(19) United States
(12) Patent Application Publication
(10) Pub. No.: US 2014/0258792 A1
(43) Pub. Date: Sep. 11, 2014

(54) Symmetrical Data Replication For Failure Management In Non-Volatile Memory Systems

(71) Applicants: Ross S. Scouller, Austin, TX (US); Jeffrey C. Cunningham, Austin, TX (US)

(72) Inventors: Ross S. Scouller, Austin, TX (US); Jeffrey C. Cunningham, Austin, TX (US)

(21) Appl. No.: 13/791,012

(22) Filed: Mar. 8, 2013

(51) Int. Cl. G06F 12/02; G06F 11/00

(52) U.S. Cl. CPC G06F 12/0246; G06F 11/006
USPC 714/57; 711/102

(57) ABSTRACT

Methods and systems are disclosed for symmetrical replication of data within multiple data subsystems for failure management in non-volatile memory (NVM) systems. Disclosed embodiments perform symmetrical write operations to multiple different data block subsystems so that duplicate subsystems are created. As the subsystems are operated symmetrically, address locations and pointers are the same for each subsystem. If an error is detected in data within one subsystem, the duplicated data at the same symmetrical location within a duplicate subsystem can be used. As such, the endurance and lifetime of NVM systems is greatly enhanced. These extended lifetime NVM systems can then be used, for example, to emulate EEPROM (erasable programmable read only memory) systems.

### TECHNICAL FIELD

The technical field relates to non-volatile memory (NVM) systems and, more particularly, to emulated EEPROM (electrically erasable programmable read only memory) systems and to failure management within such emulated EEPROM systems.

### BACKGROUND

Non-volatile memory (NVM) systems are utilized in a wide range of products. For some devices, NVM systems are used to emulate other memory systems including other NVM systems, such as EEPROM (electrically erasable programmable read only memory) systems. For example, memory blocks within NVM systems can be used to implement an emulated EEPROM system by storing one or more EEPROM data records. EEPROM data records are collections of data items and/or fields that are arranged for processing as if stored in a EEPROM. The data records can be configured to include a data record status field, a data field, and/or other desired fields. The specific arrangement required for a particular EEPROM data record is determined by the application within which the EEPROM records are being utilized. When EEPROM systems are emulated using NVM systems, the NVM systems are configured to provide data records that emulate the EEPROM records in the format being utilized.

For some applications, such as automotive applications, it is desirable to extend the life of EEE (emulated EEPROM) systems, which are implemented using NVM systems, beyond their current useful lifetimes. However, to achieve these extended lifetimes, NVM systems must be able to overcome failure mechanisms that are typically debilitating or fatal to the reliable operation of the NVM system, such as read failures due to multiple bit errors. Other failure mechanisms can also limit the useful lifetime of an NVM system, such that it is not useful for certain applications.

FIG. 1 (Prior Art) is a block diagram of an embodiment 100 for a prior NVM system that rewrites blocks of data in which errors are detected. The NVM system embodiment 100 depicted includes memory control circuitry 102 and a non-volatile memory (NVM) 120. The memory control circuitry 102 communicates with external circuitry using control signals (CNTL) 108, data signals (DATA) 110, and address signals (ADDR) 112. The memory control circuitry 102 in turn communicates with the NVM memory 102 using control signals (CNTL) 114, data signals (DATA) 116, and address signals (ADDR) 118. As depicted, the memory control circuitry 102 includes bad block rewrite circuitry 104. The NVM 120 includes program blocks 122 and data blocks 124. The program blocks 122 are configured to store program instructions that can be read and used, for example, by an external processor that communicates with the NVM system. The data blocks 124 are configured to store data, such as data for emulated EEPROM records, that are written to and read from the NVM 120. Further, the data blocks 124 are configured to include normal blocks 126 and separate rewrite blocks 128. Blocks 126 are utilized as primary data storage, and rewrite blocks 128 are utilized to store data rewritten from one or more blocks within the blocks 126 that have been determined to be bad or failed blocks.

During operation of the embodiment 100 depicted, the memory control circuitry 102 communicates with the NVM 120 to perform NVM operations. For example, the memory control circuitry 102 may receive from external circuitry a request to write data to the NVM 120 and/or a request to read data from the NVM 120. If one of the normal storage blocks 126 is determined to have errors during NVM operations, this block is marked as a bad or failed block and is no longer used by the NVM system. A bad block rewrite operation 130 is then used to rewrite data from the bad block within normal blocks 126 to a new block within rewrite blocks 128. The new block within rewrite blocks 128 is then used instead of the bad block within the primary blocks 126 for future access requests that relate to the data records rewritten into the new rewrite block. The memory control circuitry 102 utilizes the bad block rewrite circuitry 104 to control the rewrite of data from bad blocks to new blocks within the rewrite blocks 128. The bad block rewrite circuitry 104 is also used to keep track of the address locations for data records that were rewritten from failed blocks within the normal blocks 126 into the rewrite blocks 128. As such, a future request is routed to the rewrite blocks 128 instead of the normal blocks 126.

### DESCRIPTION OF THE DRAWINGS

It is noted that the appended figures illustrate only example embodiments and are, therefore, not to be considered as limiting the scope of the present invention. Elements in the figures are illustrated for simplicity and clarity and have not necessarily been drawn to scale

FIG. 1 (Prior Art) is a block diagram of an embodiment for a prior NVM system that rewrites blocks of data in which errors are detected.

FIG. 2 is a block diagram of an embodiment for an NVM system that maintains two or more symmetrical memory subsystems.

FIG. 3 is a block diagram of an embodiment for conducting symmetrical writes to multiple subsystems within the NVM system.

FIG. 4 is a block diagram of an embodiment for conducting read from one of multiple symmetrical subsystems within the NVM system.

FIG. 5 is process flow diagram of an embodiment for conducting a symmetrical write to multiple subsystems within an NVM system.

FIG. 6 is a process flow diagram of an embodiment for conducting a read from multiple symmetrical subsystems within an NVM system.

FIG. 7 is a process flow diagram of an embodiment for flagging main record data as invalid upon detection of a data error.

FIG. 8 is a process flow diagram of an embodiment for flagging duplicate record data as invalid upon detection of a data error.

### DETAILED DESCRIPTION

Methods and systems are disclosed for symmetrical replication of data within multiple data subsystems for failure management in non-volatile memory (NVM) systems. Disclosed embodiments perform symmetrical write operations to multiple different data block subsystems so that duplicate subsystems are created. As the subsystems are operated symmetrically, address locations and pointers are the same for each subsystem. If an error is detected in data within one subsystem, the duplicated data at the same symmetrical location within a duplicate subsystem can be used. As such, the endurance and lifetime of NVM systems is greatly enhanced. These extended lifetime NVM systems can then be used, for example, to emulate EEPROM (erasable programmable read only memory) systems for applications where extremely long endurance and device lifetimes are desirable. Different features and variations can be implemented, as desired, and related or modified systems and methods can be utilized, as well.

As described herein, the disclosed embodiments provide improved failure management for NVM systems by providing symmetrical replication of data within multiple data block subsystems. The disclosed embodiments are configured to manage two or more identical memory subsystems within the NVM system so that multiple symmetrical versions of data exist at all times within the NVM system. As further described herein, one application for the NVM system embodiments described herein is in implementing emulated EEPROM systems. The NVM systems embodiments described herein could also be utilized for other applications, if desired.

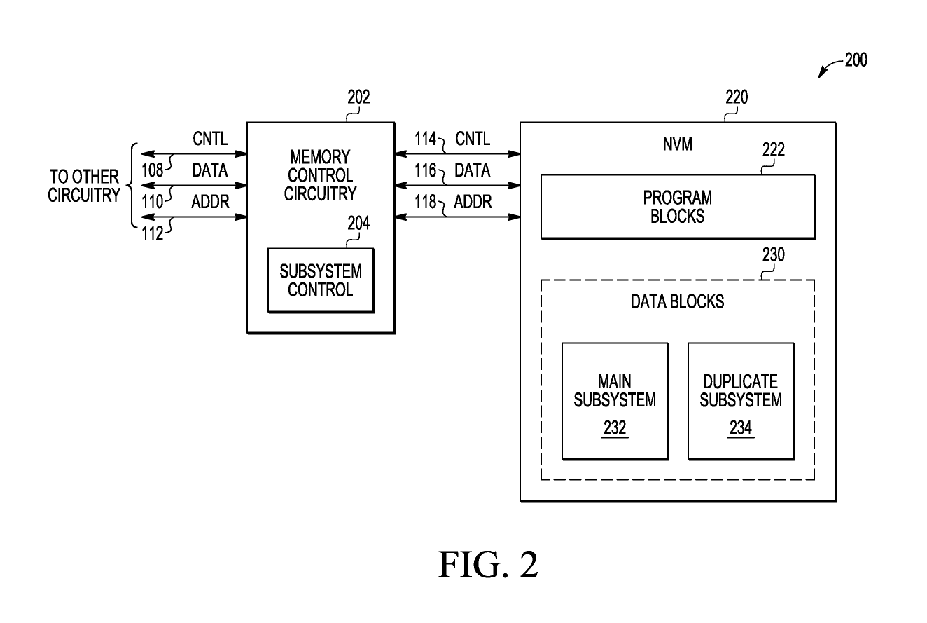

FIG. 2 is a block diagram of an embodiment 200 for an NVM system that maintains two or more symmetrical memory subsystems. NVM system embodiment 200 includes memory control circuitry 202 and a non-volatile memory (NVM) 220. The memory control circuitry 202 communicates with external circuitry using control signals (CNTL) 108, data signals (DATA) 110, and address signals (ADDR) 112. The memory control circuitry 102 in turn communicates with the NVM memory 102 using control signals (CNTL) 114, data signals (DATA) 116, and address signals (ADDR) 118. As depicted, the memory control circuitry 102 includes subsystem control circuitry 204. The NVM 220 includes program blocks 222 and data blocks 230. The program blocks 222 are configured to store program instructions that can be read and used, for example, by an external processor that communicates with the NVM system. The data blocks 230 are configured to store data, such as data for emulated EEPROM records, that are written to and read from the NVM 220. For the embodiment depicted, the data blocks 230 include two symmetrical subsystems. These symmetrical subsystems are main subsystem 232 and duplicate subsystem 234. It is noted that additional duplicate subsystems could also be provided, if desired, to provide further symmetrical copies of the stored data.

During operation of the embodiment 200 depicted, the memory control circuitry 202 communicates with the NVM memory 220 to perform NVM operations. For example, external circuitry may communicate with the memory control circuitry 202 to request a write of data to the NVM 220 and/or to request a read of data from the NVM 220. For write operations, the memory control circuitry 202 utilizes the subsystem control circuitry 204 to perform symmetrical write operations within the main subsystem 232 and the duplicate subsystem 234. For read operations, the memory control circuitry 202 utilizes the subsystem control circuitry 204 to read data from the main subsystem 232 or from the duplicate subsystem 234. If an error or failure is detected with respect to the data read from the main subsystem 232, the memory control circuitry 202 utilizes the subsystem control circuitry 204 to read data from the duplicate subsystem 234 rather than from the main subsystem 232. It is again noted that additional symmetrical duplicate subsystems can also be included, if desired. Further, it is noted that NVM 220 can be implemented using a variety of different types of NVM cells, such as split-gate NVM cells, floating-gate NVM cells, and/or other desired types of NVM cells.

Advantageously, with respect to the disclosed embodiments, when an error occurs in the data for one subsystem, the data can be obtained from the symmetrical subsystem. It is further noted that the disclosed embodiments can utilize a variety of different information to determine whether or not an error has occurred with respect to data for a subsystem. For example, the disclosed embodiments can utilize record status information and/or sector status information related to stored data as an indication of data errors. If a record status type and/or a sector status type is recognized as not valid or as an incorrect status, then the associated data can be deemed not to be reliable. Further, ECC (error correction code) faults associated with single-bit and multi-bit read errors and/or other data errors can be used as an indication that data is not reliable. Once data within one subsystem is deemed unreliable, the NVM system can be configured to automatically switch to the symmetrical subsystem to obtain a valid record containing the desired data.

By maintaining two or more symmetrical subsystems of NVM memory cells, the embodiments described herein are able to overcome failure mechanisms and thereby extend the lifetime of the NVM system, while reducing processing time and complexity in addressing failure mechanisms. Records within the data blocks 230 can be configured to include any desired information. For example, records can include address information, record status information, record data, and/or other desired information. Further, the data records can be configured to emulate EEPROM data records, if desired. As described herein, records can be deemed to be invalid, such that duplicate records in one or more symmetrical duplicate subsystems are accessed instead, if errors are detected with respect to the main record or its data. For example, a record can be deemed an invalid or failed record if ECC (error correction code) routines detect single-bit or multi-bit read errors, if record status types are invalid, and/or if other selected failure criteria is met.

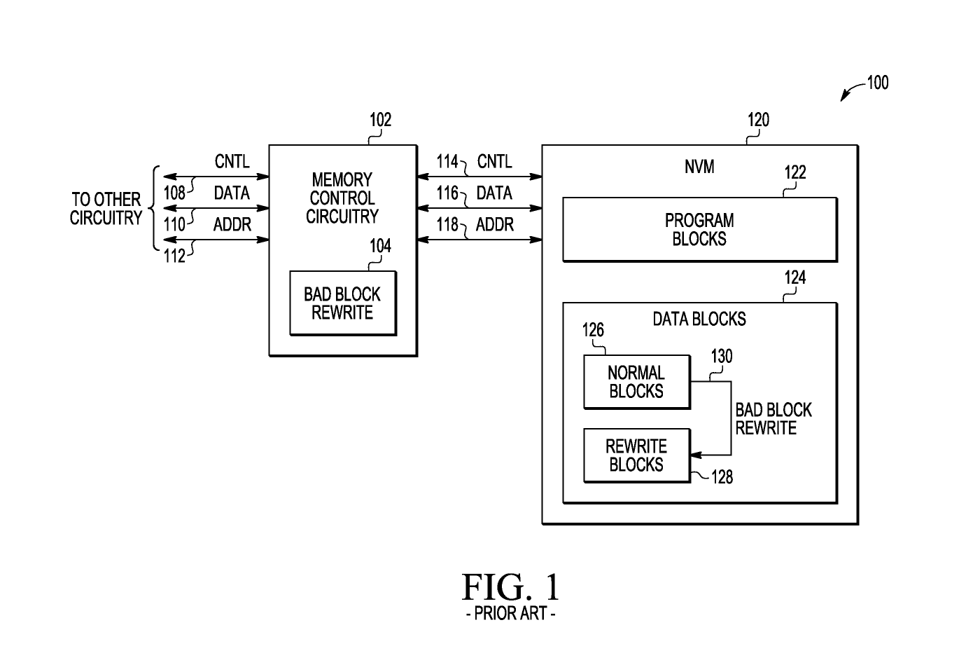

It is further noted that the disclosed embodiments can be implemented by splitting the data blocks available for a given NVM system in half (e.g., two 256K data blocks), thereby allocating half to a main data block subsystem and half to a duplicate data block subsystem. As such, record searches can be completed faster because only half of the data blocks need to be searched. Successful failure management is still provided as the duplicate data block subsystem are used to recover failed data within the main data block subsystem. The speed of this recovery is relatively fast because the duplicate subsystems are symmetrically managed so that the location of data is identical within the duplicate subsystems. As such, while additional writes are required to maintain the symmetrical data within the subsystems, the write commands require little, if any, additional overhead because the subsystems and internal data locations are symmetrical. It is further noted that based upon probabilities, it is very unlikely that the same data locations with two symmetrical subsystems would fail. As such, the symmetrical data management described herein provides an effective and efficient solution by reducing the size of main data block subsystem, while still providing for failure recovery using the duplicate data block subsystem. In contrast, the prior solution shown in FIG. 1 (Prior Art) utilizes a single data block (e.g., one 512k data block) that includes normal blocks and rewrite blocks for failure management. This large block sizes increase search times and slows NVM system performance.

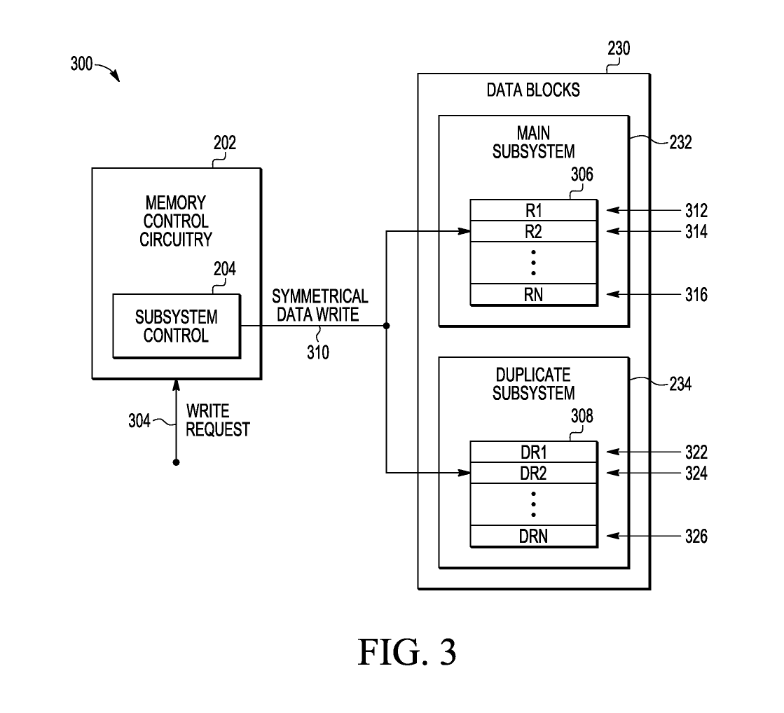

FIG. 3 is a block diagram of an embodiment 300 for conducting symmetrical writes to multiple subsystems of NVM cells within the NVM system. For the embodiment 300 depicted, the data blocks 230 include a data sector 306 within the main subsystem 232 and a data sector 308 within the duplicate subsystem 234. The data sector 306 holds multiple records including first record (R1) 312, second record (R2) 314 . . . to Nth record (RN) 316. These records 312, 314 . . . 316 are utilized to store data written to the NVM cells within the NVM system. As described herein, the duplicate subsystem 234 is managed symmetrically to be a duplicate of the main subsystem 323. Data sector 308, therefore, holds multiple duplicate records including first duplicate record (DR1) 322 that duplicates the first record (R1) 312, second duplicate record (DR2) 324 that duplicates the second record (R2) 314 . . . to Nth duplicate record (DRN) 326 that duplicates the Nth record (RN) 316. It is noted that additional sectors and associated records could also be provided, if desired.

During operation, the memory control circuitry 202 receives a write request 304, for example, from external circuitry through connections 108, 110, and 112 described with respect to embodiment 200 above. The memory control circuitry 202 then utilizes the subsystem control circuitry 204 to perform a symmetrical data write 310 to the duplicate subsystems 232 and 234 within the data blocks 230. As shown, the symmetrical data write 310 is writing to the second record (R2) 314 within sector 306 for the main subsystem 232 and to the second duplicate record (DR2) 324 within sector 308 for the duplicate subsystem 234.

It is noted that any record operation (e.g., compression, brownout recovery, etc.) performed on records within the main subsystem 232 is also performed on the matching record within the duplicate subsystem 234. Because the subsystems are operated symmetrically, record positions with one subsystem correspond to the same record positions in the other duplicate subsystems. To keep the subsystems symmetrical, a failure to program data within one subsystem can be considered a failure in the other subsystem so that program pointers will match between the symmetrical subsystems. Further, it is noted that duplicate subsystems can be stored within different memory blocks within the NVM system or within the same memory block within the NVM system, as desired. With respect to embodiments with duplicate subsystems stored in different memory blocks, the data can be programmed in parallel, if desired. Alternatively, the data can be programmed serially within the different memory blocks, if desired. With respect to embodiments with duplicate subsystems in the same memory block, the data can be programmed serially. Further, for NVM systems that allow a ganged write mode, two rows within the same block can be paired together for programming, but then read separately. For example, a row in the main subsystem and the matching row in the duplicate subsystem can be paired for writes, but then read separately. It is further noted that serial programming can help to facilitate the identification of brownout points between subsystems as compared to parallel programming. Other variations could also be implemented, as desired.

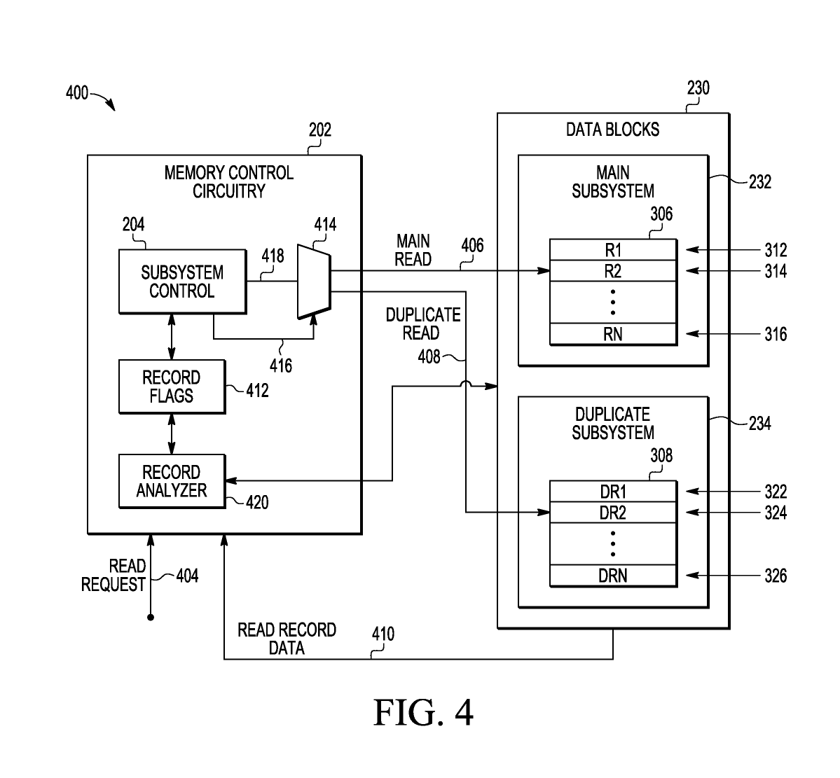

FIG. 4 is a block diagram of an embodiment 400 for reading data from one of multiple symmetrical subsystems of NVM cells within the NVM system. For the embodiment 400 depicted, the data blocks 230 again include a data sector 306 within the main subsystem 232 and a data sector 308 within the duplicate subsystem 234. The data sector 306 again includes first record (R1) 312, second record (R2) 314 . . . to Nth record (RN) 316. As described above, the duplicate subsystem 234 is managed symmetrical to be a duplicate of the main subsystem 323. Data sector 308, therefore, again includes first duplicate record (DR1) 322 that duplicates the first record (R1) 312, second duplicate record (DR2) 324 that duplicates the second record (R2) 314 . . . to Nth duplicate record (DRN) 326 that duplicates the Nth record (RN) 316. For the embodiment 400, the memory control circuitry 202 also includes record flags block 412, record analyze 420, and multiplexer (MUX) 414. The record analyze 420, which is discussed further below, is utilized to analyze records within the data blocks 230 to determine if records are valid. The record flags block 412 is used to store flag data that identify records within the main subsystem 232 that have been determined to be defective or unreliable. The validity of records within other duplicate subsystems could also be tracked using the record flags block 412, if desired. The MUX 414 receives the read command information 418 from the subsystem duplication block 204 and provides this read command information as a main read command 406 to the main subsystem 232 or as a duplicate read command 408 to duplicate subsystem 234, depending upon the subsystem selection signal 416. It is noted that the main read command 406 and the duplicate read command 408 can be provided to the data blocks 230 within NVM 120 using the connections 114, 116, and 118 described with respect to embodiment 200 above.

During operation, the memory control circuitry 202 receives a read request 404, for example, from external circuitry through connections 108, 110, and 112 described with respect to embodiment 200 above. The memory control circuitry 202 then utilizes the subsystem control circuitry 204 to perform a read from one of the duplicate subsystems within the data blocks 230 for the NVM 120. First, the subsystem control circuitry 204 determines the record or records that contain the data to be read. Because the subsystems are managed to be symmetrical so that they are duplicates of each other, the data location is identical within the two subsystems 232 and 234. The subsystem control circuitry 204 then checks the record flags block 412 to determine if any of the records to be accessed within the main subsystem 232 has been marked as a defective or unreliable record. If a record has not been marked as defective or unreliable, the subsystem control circuitry 204 applies the subsystem selection signal 416 to select a main read 406 from the main subsystem 232. If a record has been marked as defective or unreliable, the subsystem control circuitry 204 applies the subsystem selection signal 416 to select a duplicate read 408 from the duplicate subsystem 232. For the embodiment 400 shown, the data read operation is reading data from the second record (R2) 314 within sector 306 for the main subsystem 232 or from the second duplicate record (DR2) 324 within sector 308 for the duplicate subsystem 234. Once the data is read from one of the subsystems, the read record data 410 is provided from the data blocks 230 within the NVM 120 to the memory control circuitry 202. The memory control circuitry 202 can then provide this read data back to the requesting device.

It is noted that a programmable address sequencer could be utilized, if desired, within the memory control circuitry 202 for facilitating and/or automating large serial read operations. One situation where large serial read operations may occur is during copy down operations where all record data contents are copied to an external memory, such as an electrically erasable random access memory (EERAM), from oldest record to newest record. Another situation where large serial read operations may occur is during a search operation where records are compared against a known record type from newest record to oldest record until a match occurs. If included within the memory control circuitry 202, the programmable address sequencer could also be utilized in other situations, if desired.

As indicated above, it is noted that the data records stored within the data blocks 230 can include a wide range of information, such as record status information, record creation information (e.g., date/time created), data information, and/or other desired information. Further, the data records can be any desired size (e.g., 32 bits or some other size). For some embodiments, record creation information is utilized to search records (e.g., oldest to newest record, newest to oldest record), to communicate records externally (e.g., oldest to newest record, newest to oldest record), and/or for other desired purposes. For some embodiments, the record status information can be used to determine valid records and can be implemented, if desired, as a multiple-bit data word (e.g., 8-bit, 7-bit, or other length) that indicates a current status type for a stored record. Other variations can also be implemented, as desired.

The record analyzer 420 within the memory control circuitry 202 can be utilized to analyze the record status information to determine if the record status is valid. For example, this record status information can be analyzed during copy down operations, where records are re-organized from oldest to newest record or from newest to oldest record. If a record status type is detected that is deemed invalid by the record analyzer 420, the record can be deemed to be a failed or unreliable record. The record analyzer 420 can then flag the record as invalid within the record flags block 412. The subsystem control circuitry 204 can the use an alternate symmetrical subsystem for any data reads that are directed to this failed record. Other variations can also be implemented, as desired.

It is further noted that sectors can store sector status information and/or sector identification (ID) information in addition to holding a plurality of records. Errors detected in this sector status information or sector ID information can also be utilized to determine if a sector is valid. As with invalid records, when an invalid sector is detected, an alternate symmetrical subsystem can then be utilized for any data reads that are directed to this failed sector. For some embodiments, sector ID information is utilized to determine the starting and ending addresses for stored data records for the sector. As such, an uncorrectable error within the sector ID information can be a significant failure in prior systems, as the bounds of the sector can no longer be determined. In contrast, using the embodiments described herein, symmetrical sector ID information from the alternate symmetrical subsystem can be utilized if a failure occurs within the sector ID information for the main symmetrical subsystem. As such, this failure can be overcome. Other variations can also be implemented, as desired.

As also indicated above, errors that occur during data read operations can also be utilized to indicate failed or unreliable data records. For example, if a single-bit or multi-bit error is detected by an ECC routine during a read operation, the records associated with the data read can be deemed invalid. The alternate symmetrical subsystem can then be utilized for any data reads that are directed to this failed record. Further, the alternate symmetrical subsystem can be utilized in combination with the main symmetrical subsystem to determine further information about the ECC error. For example, by using multiple symmetrical subsystems, the NVM system could potentially determine if a single-bit error detected by an ECC routine is actually a single-bit error or a triple-bit error, as most ECC routines cannot readily distinguish between single-bit and other odd-bit errors. Using multiple symmetrical subsystems can also be utilized to enhance the correction of single-bit or multi-bit errors detected as part of a read operation. Because the data block subsystems are maintained symmetrically, the access of data within the different symmetrical subsystems is streamlined, as the addresses, pointers, and data locations are the same. Other variations can also be implemented, as desired.

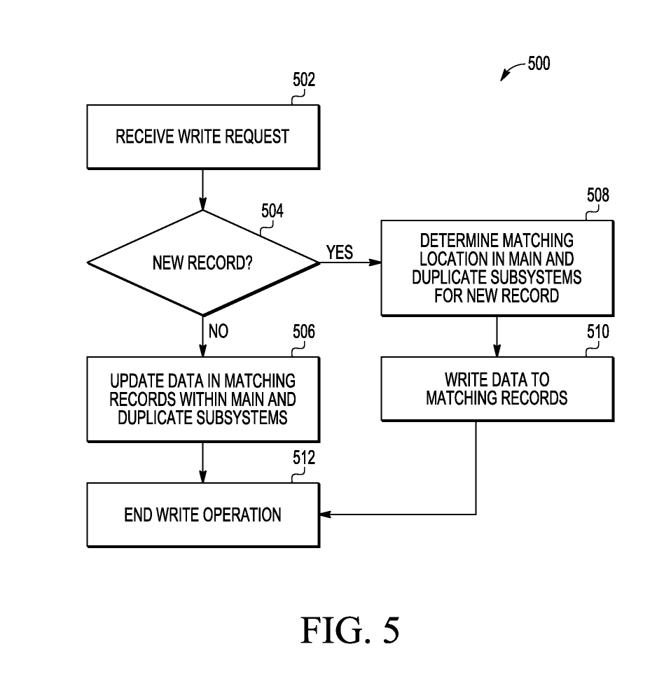

FIG. 5 is process flow diagram of an embodiment 500 for conducting a symmetrical write to multiple subsystems within an NVM system. In block 502, a write request is received. In block 504, a determination is made whether a new record is needed. If “NO” and data is being updated within an existing record, flow passes to block 506 where data is updated in matching records within the main and duplicate subsystems. Flow then passes to block 512 where the write operation ends. If the determine in block 504 is “YES” and a new records is being created, flow passes to block 508 where a matching location is determined for the new record within the main and duplicate subsystems. Flow then passes to block 510 wherein data is symmetrically written to the new matching records. Flow then passes to block 512 where the write operation ends.

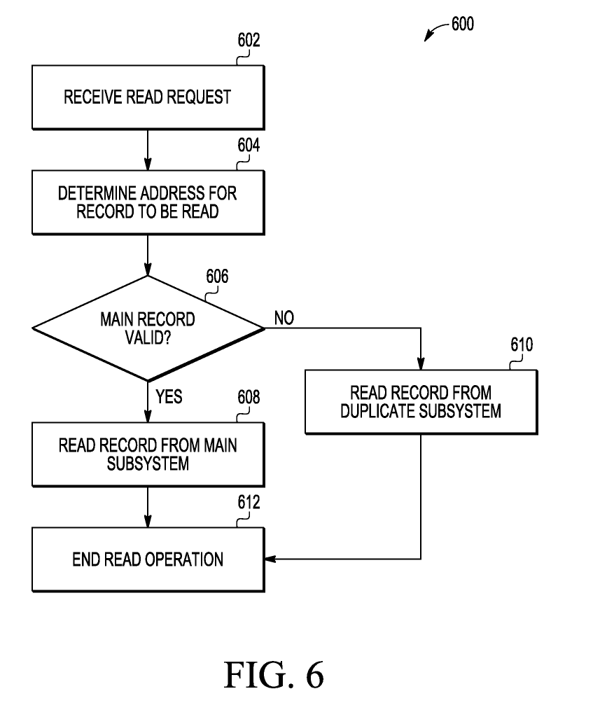

FIG. 6 is a process flow diagram of an embodiment 600 for conducting a read from multiple symmetrical subsystems within an NVM system. In block 602, a read request is received. In block 604, an address is determined for the record to be read. In block 606, a determination is made whether the record within the main subsystem is valid. If “YES” and the record within the main subsystem has not been marked as invalid (e.g., defective or unreliable), flow passes to block 608 where the record from the main subsystem is read. Flow then proceeds to block 612 where the read operation ends. If the determination in block 606 is “NO” and the record within the main subsystem has been marked as invalid (e.g., defective or unreliable), flow passes to block 610 where the record from the duplicate subsystem is read. Flow then proceeds to block 612 where the read operation ends.

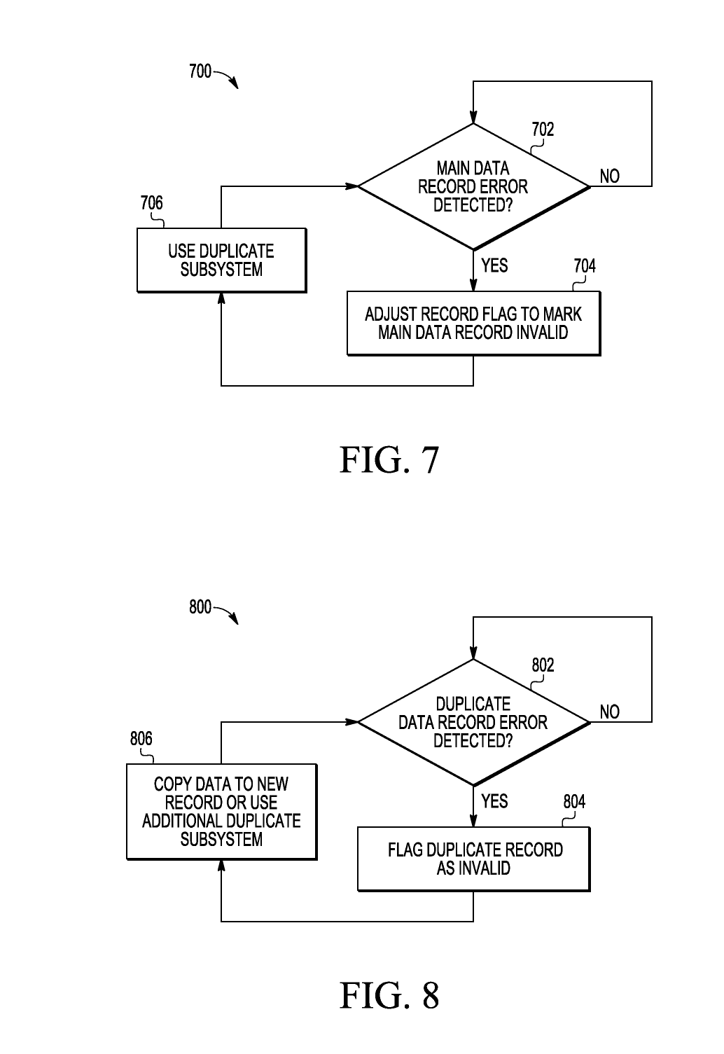

FIG. 7 is a process flow diagram of an embodiment 700 for flagging main record data as invalid upon detection of a data error. In block 702, a determination is made whether an error has been detected with respect to a data record within the main data block subsystem. If “NO,” then flow passes back to block 702. If “YES,” then flow passes to block 704 where the record flag information is adjusted to mark as invalid the main data record within which the data error occurred. Next, in block 706, a duplicate subsystem is utilized for reading data associated with the record that was marked as invalid. Flow then passes back to block 702.

FIG. 8 is a process flow diagram of an embodiment 800 for flagging duplicate record data as invalid upon detection of a data error. In block 802, a determination is made whether an error has been detected with respect to a data record within the duplicate data block subsystem. If “NO,” then flow passes back to block 802. If “YES,” then flow passes to block 804 where the duplicate record within which the data error occurred is flagged as invalid. Next, in block 806, the data associated with the invalid record can be copied to a new record within the duplicate subsystem. Alternatively, where additional duplicate subsystems are utilized (e.g., a main subsystem and two or more duplicate subsystems), an additional duplicate subsystem can be utilized for the read operation. Flow then passes back to block 802.

As described herein, a variety of embodiments can be implemented and different features and variations can be implemented, as desired.

One disclosed embodiment is a non-volatile memory (NVM) system including a plurality of data subsystems with each data subsystem including a plurality of NVM cells and being configured to hold a plurality of data record within the plurality of NVM cells, and memory control circuitry configured to conduct symmetrical memory write operations to NVM cells within the plurality of data subsystems and configured to conduct memory read operations from NVM cells within a selected one of the plurality of data subsystems.

In further embodiments, the symmetrical memory write operations can include write operations configured to keep location of data identical within the plurality of data subsystems to form a plurality of duplicate data subsystems. Further, the plurality of data subsystems can include a main data subsystem and at least one duplicate data subsystem. Still further, the memory control circuitry can be configured to select the main data subsystem for a memory read operation if data being read from the main data subsystem has not been deemed invalid, and the memory control circuitry can be configured to select a duplicate data subsystem for a memory read operation if data being read from the main data subsystem has been deemed invalid. In addition, the main data subsystem and the at least one duplicate data subsystem can be configured to be a same size. Still further, the memory control circuitry can be configured to emulate an EEPROM (electrically erasable programmable read only memory) system in response to read and write requests received from external circuitry.

In other embodiments, the memory control circuitry can be configured to store error flags identifying data records within the main data subsystem identified as having invalid data. Further, the memory control circuitry can be further configured to access the at least one duplicate subsystem when a read operation requests data within a flagged data record. Still further, the memory control circuitry can be configured to utilize error correction code (ECC) bit errors from read operations to flag data as invalid. In addition, the memory control circuitry can be configured to analyze record status information for data records and to utilize record status errors to flag data as invalid. In further embodiments, each data subsystem can further include a plurality of sectors with each sector having a plurality of data records, and the memory control circuitry can be configured to analyze sector status information and to utilize sector status errors to flag data as invalid.

Another disclosed embodiment is a method for operating a non-volatile memory (NVM) system including symmetrically writing data to NVM cells within a plurality of data subsystems with each data subsystem including a plurality of NVM cells and being configured to hold a plurality of data records within the plurality of NVM cells, and reading data from NVM cells within a selected on of the plurality of data subsystems.

In further embodiments, the symmetrical writing step comprises performing write operations configured to keep location of data identical within the plurality of data subsystems to form a plurality of duplicate data subsystems. Further, the plurality of data subsystems can include a main data subsystem and at least one duplicate data subsystem. Still further, the method can further include selecting the main data subsystem for a memory read operation if data being read from the main data subsystem has not been deemed invalid, and selecting a duplicate data subsystem for a memory read operation if data being read from the main data subsystem has been deemed invalid. In addition, the main data subsystem and the at least one duplicate data subsystem can be configured to be a same size. Still further, the method can include emulating an EEPROM (electrically erasable programmable read only memory) system in response to read and write requests received from external circuitry.

In other embodiments, the method can include storing error flags identifying data records within the main data subsystem identified as having invalid data. Further, the method can further including accessing the at least one duplicate subsystem when a read operation requests data within a flagged data record. Still further, the method can further include utilizing error correction code (ECC) bit errors from read operations to flag data as invalid. In addition, the method can include analyzing record status information for data records and utilizing record status errors to flag data as invalid. In further embodiments, each data subsystem can further include a plurality of sectors with each sector having a plurality of data records, and the method can further include analyzing sector status information and utilizing sector status errors to flag data as invalid.

It is noted that the functional blocks described herein can be implemented using hardware, software or a combination of hardware and software, as desired. In addition, one or more processors or microcontrollers running software and/or firmware can also be used, as desired, to implement the disclosed embodiments. It is further understood that one or more of the tasks, functions, or methodologies described herein may be implemented, for example, as software or firmware and/or other instructions embodied in one or more non-transitory tangible computer readable mediums that are executed by a controller, microcontroller, processor, microprocessor, or other suitable processing circuitry.

Unless stated otherwise, terms such as “first” and “second” are used to arbitrarily distinguish between the elements such terms describe. Thus, these terms are not necessarily intended to indicate temporal or other prioritization of such elements.

Further modifications and alternative embodiments of the described systems and methods will be apparent to those skilled in the art in view of this description. It will be recognized, therefore, that the described systems and methods are not limited by these example arrangements. It is to be understood that the forms of the systems and methods herein shown and described are to be taken as example embodiments. Various changes may be made in the implementations. Thus, although the invention is described herein with reference to specific embodiments, various modifications and changes can be made without departing from the scope of the present invention. Accordingly, the specification and figures are to be regarded in an illustrative rather than a restrictive sense, and such modifications are intended to be included within the scope of the present invention. Further, any benefits, advantages, or solutions to problems that are described herein with regard to specific embodiments are not intended to be construed as a critical, required, or essential feature or element of any or all the claims.

What is claimed is:

1. A non-volatile memory (NVM) system, comprising:
a plurality of data subsystems, each data subsystem comprising a plurality of NVM cells and being configured to store a plurality of data records within the plurality of NVM cells; and
memory control circuitry configured to conduct symmetrical memory write operations to NVM cells within the plurality of data subsystems and configured to conduct memory read operations from NVM cells within a selected one of the plurality of data subsystems.

2. The NVM system of claim 1, wherein the symmetrical memory write operations comprise write operations configured to keep location of data identical within the plurality of data subsystems to form a plurality of duplicate data subsystems.

3. The NVM system of claim 1, wherein the plurality of data subsystems comprise a main data subsystem and at least one duplicate data subsystem.

4. The NVM system of claim 3, wherein the memory control circuitry is configured to select the main data subsystem for a memory read operation if data being read from the main data subsystem has not been deemed invalid, and wherein the memory control circuitry is configured to select a duplicate data subsystem for a memory read operation if data being read from the main data subsystem has been deemed invalid.

5. The NVM system of claim 4, wherein the main data subsystem and the at least one duplicate data subsystem are configured to be a same size.

6. The NVM system of claim 3, wherein the memory control circuitry is configured to store error flags identifying data records within the main data subsystem identified as having invalid data.

7. The NVM system of claim 6, wherein the memory control circuitry is further configured to access the at least one duplicate subsystem when a read operation requests data within a flagged data record.

8. The NVM system of claim 7, wherein the memory control circuitry is configured to utilize error correction code (ECC) bit errors from read operations to flag data as invalid.

9. The NVM system of claim 7, wherein the memory control circuitry is configured to analyze record status information for data records and to utilize record status errors to flag data as invalid.

10. The NVM system of claim 7, wherein each of the plurality of data subsystems further comprises a plurality of sectors, each sector having a plurality of data records, and wherein the memory control circuitry is configured to analyze sector status information and to utilize sector status errors to flag data as invalid.

11. The NVM system of claim 1, wherein memory control circuitry is configured to emulate an EEPROM (electrically erasable programmable read only memory) system in response to read and write requests received from external circuitry.

12. A method for operating a non-volatile memory (NVM) system, comprising:
symmetrically writing data to NVM cells within a plurality of data subsystems, each data subsystem comprising a plurality of NVM cells and being configured to store a plurality of data records within the plurality of NVM cells; and
reading data from NVM cells within a selected on of the plurality of data subsystems.

13. The method of claim 12, wherein the symmetrical writing step comprises performing write operations configured to keep location of data identical within the plurality of data subsystems to form a plurality of duplicate data subsystems.

14. The method of claim 12, wherein the plurality of data subsystems comprise a main data subsystem and at least one duplicate data subsystem.

15. The method of claim 14, further comprising selecting the main data subsystem for a memory read operation if data being read from the main data subsystem has not been deemed invalid, and selecting a duplicate data subsystem for a memory read operation if data being read from the main data subsystem has been deemed invalid.

16. The method of claim 15, wherein the main data subsystem and the at least one duplicate data subsystem are configured to be a same size.

17. The method system of claim 14, further comprising storing error flags identifying data records within the main data subsystem identified as having invalid data.

18. The method of claim 17, further comprising accessing the at least one duplicate subsystem when a read operation requests data within a flagged data record.

19. The method of claim 18, further comprising utilizing error correction code (ECC) bit errors from read operations to flag data as invalid.

20. The method of claim 18, further comprising analyzing record status information for data records and utilizing record status errors to flag data as invalid.

21. The method of claim 18, wherein the data subsystems further comprise a plurality of sectors, each sector having a plurality of data records, and further comprising analyzing sector status information and utilizing sector status errors to flag data as invalid.

22. The method of claim 12, further comprising emulating an EEPROM (electrically erasable programmable read only memory) system in response to read and write requests received from external circuitry.
